(19) United States
(12) Patent Application Publication
(10) Pub. No.: US 2016/0360351 A1
(43) Pub. Date: Dec. 8, 2016

(54) BIOMETRIC AND BLUETOOTH ENABLED CASE LOCK

(71) Applicant: iWallet Corporation, San Diego, CA (US)

(72) Inventor: Steven D. Cabouli, San Diego, CA (US)

(21) Appl. No.: 15/172,528

(22) Filed: Jun. 3, 2016

Related U.S. Application Data
(60) Provisional application No. 62/170,743, filed on Jun. 4, 2015.

(51) Int. Cl. H04W 4/00; G08B 13/14; G06K 9/00; G08B 5/36

(52) U.S. Cl. CPC H04W 4/008; G08B 5/36; G08B 13/1436; G06K 9/00013; G06K 9/00087; G06K 9/00926; H04M 2250/10

(57) ABSTRACT

The present invention is directed to a Biometric and Bluetooth Enabled Case Lock System and method that provides a unique apparatus for locking enclosures such as luggage, briefcases, lockers, lock boxes and cabinets, and the like, with indirect operational control by the means of a smart phone, tablet or a computer. The Biometric and Bluetooth Enabled Case Lock system contains a biometric based finger print authentication module, and a Bluetooth communications enabled module, to prevent a non-owner or unauthorized user from accessing the device. An on-board system processor controls and interprets commands passed from the user's external Bluetooth device, whereby said case lock system is controllable via an application on a smartphone, tablet or a computer.

### FIELD OF THE INVENTION

This application provides a unique apparatus for locking enclosures such as luggage, briefcases, lockers, lock boxes and cabinets, and the like, with indirect operational control by the means of a smart phone, tablet or a computer. More particularly, a biometric and Bluetooth enabled Case Lock system is provided, wherein an on-board system processor controls and interprets commands passed from the user's external Bluetooth device, whereby said case lock system is controllable via an application on a smartphone, tablet or a computer.

### BACKGROUND OF THE INVENTION

The present invention pertains generally to a wide variety of cases and enclosures with improved security features. More specifically, the present invention pertains to systems and methods for securing enclosures such as luggage, briefcases, lockers, lock boxes and cabinets, and the like, while employing electronic features communicating with a smart phone, tablet or a computer. The present invention is particularly useful as a method with advanced features including biometric authentication and an ability to transmit and receive electronic signals.

In an age where electronic devices and transactions are prevalent, safe-guarding data within enclosures such as luggage, briefcases, lockers and cabinets has become an important issue, thus giving rise to a myriad of security systems. Two of the common security systems used are, password and personal identification (PIN) systems. Password systems require a user to provide the authentication system with a username and a password (both of which are unique to the user). PIN systems on the other hand usually require a user to provide a code, usually referred to as the PIN code, for authentication purposes. Both the password and the PIN system can prove to be a nuisance to users in the event they forget their password or PIN code. Moreover, a user A can easily impersonate another user B if user A happens to get a hold of the password or PIN code (given either voluntarily or exploited through other means) of user B. One way to avoid such breaches of security is to implement a user-based physiological or behavioral characteristic as a means for authentication. This is the general idea behind biometrics.

Biometrics is the study of measurable biological characteristics. In computer security, biometrics refers to authentication techniques that rely on measurable physiological (e.g. face, fingerprint, hand, iris, or DNA) or behavioral (e.g. keystrokes, signature, or voice) characteristics that can be automatically checked.

In the above description, authentication is usually accomplished via a biometric device. A general description of the functionality of a biometric device now follows. First, the biometric device captures a profile of the characteristic and next, a comparison of the acquired profile is made with a stored profile or template. Lastly, upon successful matching of the captured and stored profile, the user is interfaced with the application system requesting authentication.

Authentication based on fingerprint: One of the most common biometric techniques is the fingerprint, wherein users scan in a copy of their fingerprint and a comparison is performed by the authentication device as to whether or not the input fingerprint matches that of a stored fingerprint corresponding to the same person. Some fingerprint authentication devices further provide a step of checking for a pulse to combat problems posed by false-authentication via fingerprints that are not real.

Authentication based on hand geometry captures the physical characteristics of a user's hand and fingers via a scanner and is matched with a stored template of the same user. Upon successful authentication, an action (like opening a secure door) is performed by the querying system.

Therefore, biometrics is beginning to play a critical role in authentication and security. Biometrics authenticate the user not based on what he can remember (like passwords, PIN's, etc.), but rather use the user's characteristics (or who the user is) to perform authentication.

Also recently, improvements in electronic tracking and inventory systems have been proposed that take advantage of the latest short range, low power technologies such as Bluetooth and ZigBee. However, no similar proposals have been made that specifically address enclosures such as luggage, briefcases, lockers and cabinets as in the Case Lock application, providing biometric authentication and electronic tracking.

### SUMMARY OF THE INVENTION

In this respect, before explaining at least one embodiment of the Biometric and Bluetooth Enabled Case Lock in detail it is to be understood that the design is not limited in its application to the details of construction and to the arrangement, of the components set forth in the following description or illustrated in the drawings. The Biometric and Bluetooth Enabled Case Lock is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent construction insofar as they do not depart from the spirit and scope of the present application.

The principle advantage of the Biometric and Bluetooth Enabled Case Lock is that it provides a unique apparatus for locking enclosures such as luggage, briefcases, lockers and cabinets with indirect operational control by the means of a smart phone, tablet or a computer.

Another advantage of the Biometric and Bluetooth Enabled Case Lock is that it contains a biometric based authentication module to prevent a non-owner from accessing the device. Biometrics authenticate the user not based on what he can remember but rather use the user's characteristics to perform authentication.

Another advantage of the Biometric and Bluetooth Enabled Case Lock is that it contains a Bluetooth communications enabled based authentication module to prevent a non-owner from accessing the device and provides a secure case or enclosure that is tamper resistant.

Another advantage of the Biometric and Bluetooth Enabled Case Lock is that it provides a secure case or enclosure with electronic transmission and receiving capability, for example, triggering an alarm indication when the case or enclosure are taken out of a user's preselected range.

Another advantage of the Biometric and Bluetooth Enabled Case Lock is that it will provide a secure case or enclosure with a USB port so that data can be retrieved, stored and programmed to the device via a personal smart phone or laptop computer.

Another advantage of the Biometric and Bluetooth Enabled Case Lock is that it will provide a secure case locking system and method that is simple to use, yet easy to implement and cost effective.

The Biometric and Bluetooth Enabled Case Lock provides a unique apparatus for locking enclosures such as luggage, briefcases, lockers and cabinets with indirect operational control by the means of a smart phone, tablet or a computer. The Biometric and Bluetooth Enabled Case Lock is provided having relatively low power, relatively short range, and wireless transmission capability. The Biometric and Bluetooth Enabled Case Lock can be unlocked or locked at any distance within the range of the cell phone. The Biometric and Bluetooth Enabled Case Lock is still further configured so that when it is separated by a predetermined distance, for example ten (10) feet, the Biometric and Bluetooth Enabled Case Lock will provide audio and/or vibrational indication to both the Biometric and Bluetooth Enabled Case Lock and the cell phone. The audio indication principle purpose is to alert an owner when the Biometric and Bluetooth Enabled Case Lock has been stolen or lost.

In a preferred embodiment, a biometric reader is realized as fingerprint module microprocessor that controls the actions of the range detection, for example with sound generator and vibrator, and also with authentication of the user via the fingerprint module. A Security Parameter Index (SPI) is associated with a Biometric and Bluetooth Enabled Case Lock owner's biometric signature. Microprocessor communicates to wireless module via a General Purpose Input/Output (GPIO), for example, and includes antenna. It is preferred that both processor and wireless module are low power consuming and concurrent with the latest advancements in such electronics. Further, the wireless module is configured, according to for example, short range low power protocols as defined by either Bluetooth, ZigBee (IEEE 802.15.4), Radio Frequency Identification (RFID), or Ultra-Wideband (UWB).

The present design comprises applications including registration, login, authentication, range detection, wireless stack, security library, biometric middleware, operating system, and device drivers. The operating system includes all the services such as interprocess communications, memory management, clock, and file system. Device drivers include wireless, flash, I/O ports, timers, fingerprint reader, and others. Sitting on top of the OS are the wireless communication stack, biometric library (middleware), and security library. The application layer includes applications such as sync, user registration, user authentication, and range detection, for example.

In the Biometric and Bluetooth Enabled Case Lock a biometric reader is configured to scan a fingerprint of a person attempting to access the Biometric and Bluetooth Enabled Case Lock. The LED is designed to emit green when processor recognizes the fingerprint as the owner. Also, a chime is emitted from sound generator when a successful authentication is received. Additionally, LED is designed to emit red light, and sound generator will emit a warning buzzer, when the biometric reader scans a fingerprint other than what the processor recognizes as the owner. Still further, LED is designed to emit amber light when battery power for the Case Lock is below a threshold level and also sound generator will emit an intermittent beeping sound. In a preferred embodiment, recharging of the battery power can be achieved via the mini USB port to a charger that plugs into an AC power supply. Alternatively, a separate port for an AC adapter can be provided as a design choice.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Biometric and Bluetooth Enabled Case Lock. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Biometric and Bluetooth Enabled Case Lock and together with the description, serve to explain the principles of this application.

FIG. 1 depicts a perspective view of a typical suitcase, the Biometric and Bluetooth Enabled Case Lock assembly and a typical smart phone.

FIG. 2 depicts a perspective view of the internal workings of the Biometric and Bluetooth Enabled Case Lock assembly.

FIG. 3 depicts a plan view of the internal workings of the Case Lock with the latch links retracted.

FIG. 4 depicts a plan view of the internal workings of the Biometric and Bluetooth Enabled Case Lock with the latch links extended.

FIG. 5 depicts an exploded view of the Biometric and Bluetooth Enabled Case Lock assembly illustrating the latch link assembly and the circuit board assembly.

FIG. 6 depicts an exploded view of the Biometric and Bluetooth Enabled Case Lock mechanical components.

FIG. 7A depicts a block diagram illustration of the system for securing the Biometric and Bluetooth Enabled Case Lock, including the motor control, lock, Bluetooth antenna and Bluetooth module as well as optional mass storage, GPS and motion sensor.

FIG. 7B depicts a block diagram illustration of the hardware components for the Biometric and Bluetooth Enabled Case Lock assembly, including the main processor, speaker driver and speaker, as well as the USB port and battery power supply configurations.

FIG. 7C depicts a block diagram illustration hardware and software components for the Biometric and Bluetooth Enabled Case Lock assembly, including the fingerprint reader, internal lights and user interface.

For a fuller understanding of the nature and advantages of the Biometric and Bluetooth Enabled Case Lock, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

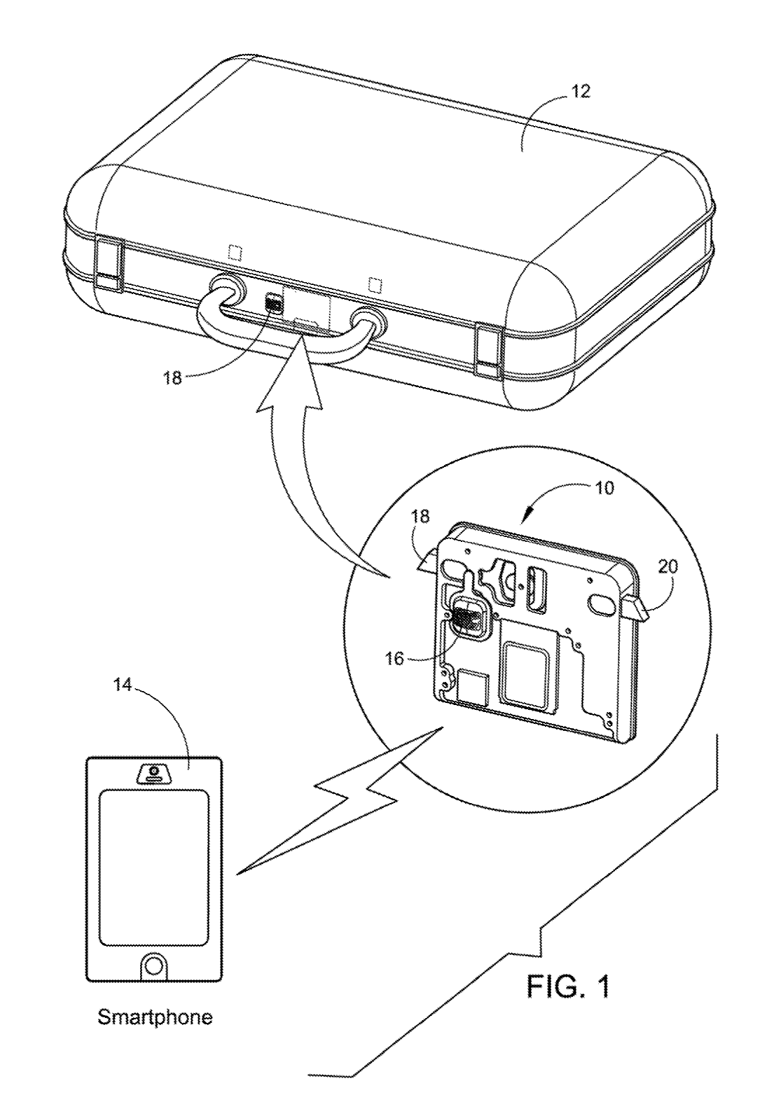

Referring now to the drawings, wherein similar parts of the Biometric and Bluetooth Enabled Case Lock 10 are identified by like reference numerals, there is seen in FIG. 1 a perspective view of a typical brief case or suitcase 12, the Biometric and Bluetooth Enabled Case Lock 10 assembly and a typical smart phone 14. The perspective view of the Biometric and Bluetooth Enabled Case Lock 10 assembly illustrates the finger print sensor 16 that when correct finger print is recognized, the top latch link 18 and the bottom latch link 20 are retracted.

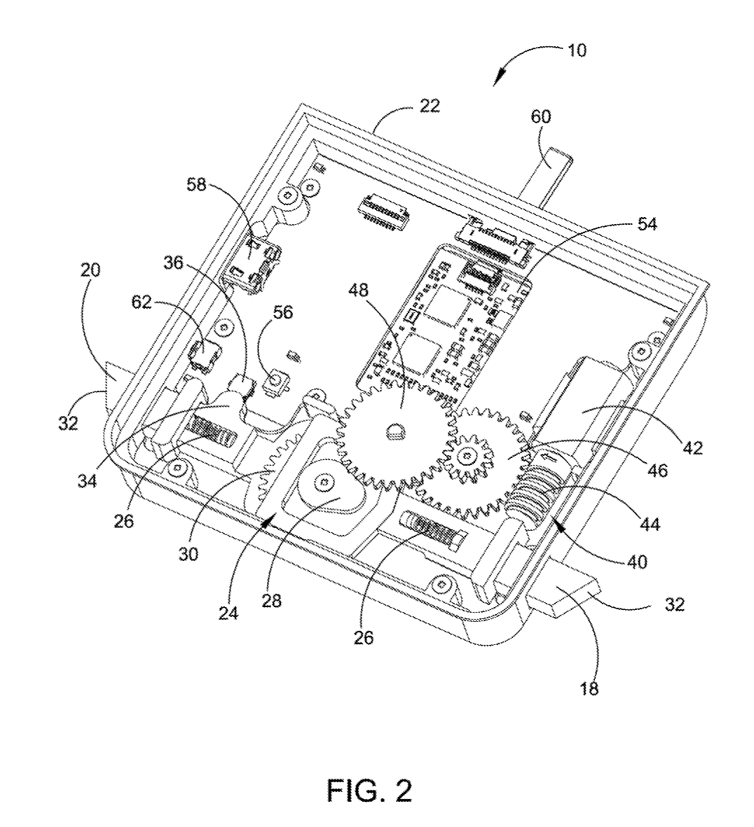

FIG. 2 depicts a perspective view of the internal workings of the Biometric and Bluetooth Enabled Case Lock 10 assembly with the case lock frame 22 housing the latch link assembly 24. The latch link assembly 24 consists of the top latch link 18 and the bottom latch link 20, latch return springs 26 and the top and bottom cams 28 on the thirty-six tooth gear assembly 30. The chamfers 32 allow the latch links 18 and 20 to have clearance for the latch return springs 26 and the top and bottom cams 28 to position the top latch link 18 and the bottom latch link 20 in the lock position. When the drive motor 42 and worm gear 44 are activated the rotational gear assembly 40 moves the top and bottom cams 28 ninety degrees to move the latch links 18 and 20 to the unlocked position. The extended feature 34 on the bottom latch link 20 activates the shutoff switch 36 when the cams 28 are rotated with the thirty-six tooth gear assembly 30.

The reduction gear assembly 40 consists of a drive motor 42 with a worm gear 44 driving a thirty-two tooth gear incorporating a twelve tooth gear 46 driving a thirty-two tooth gear incorporating a twelve tooth gear 48 that drives the thirty-six tooth gear assembly 30 of the latch link assembly 24.

The PCB (printed circuit board) 54 controlling the functions of the Biometric and Bluetooth Enabled Case Lock 10 is coupled to the Bluetooth button 56, the USB charging port 58 and the antenna 60 and the unit reset activator 62.

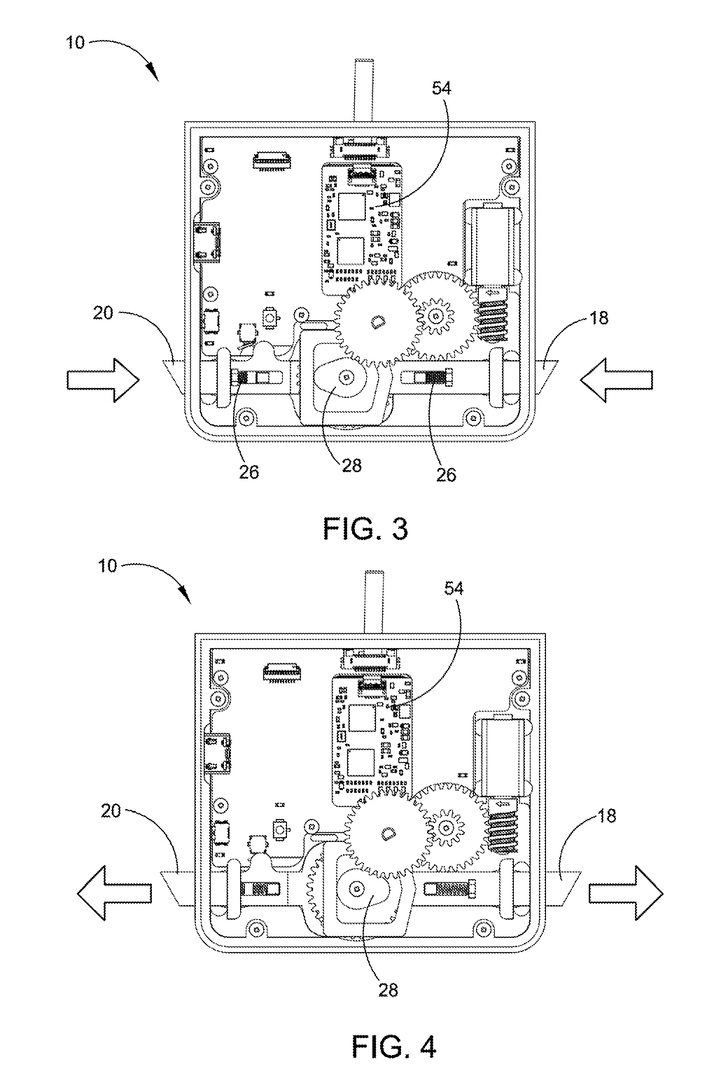

FIG. 3 depicts a plan view of the internal workings of the Biometric and Bluetooth Enabled Case Lock with the latch links 18 and 20 retracted with the latch return springs 26 compressed.

FIG. 4 depicts a plan view of the internal workings of the Biometric and Bluetooth Enabled Case Lock with the latch links 18 and 20 extended.

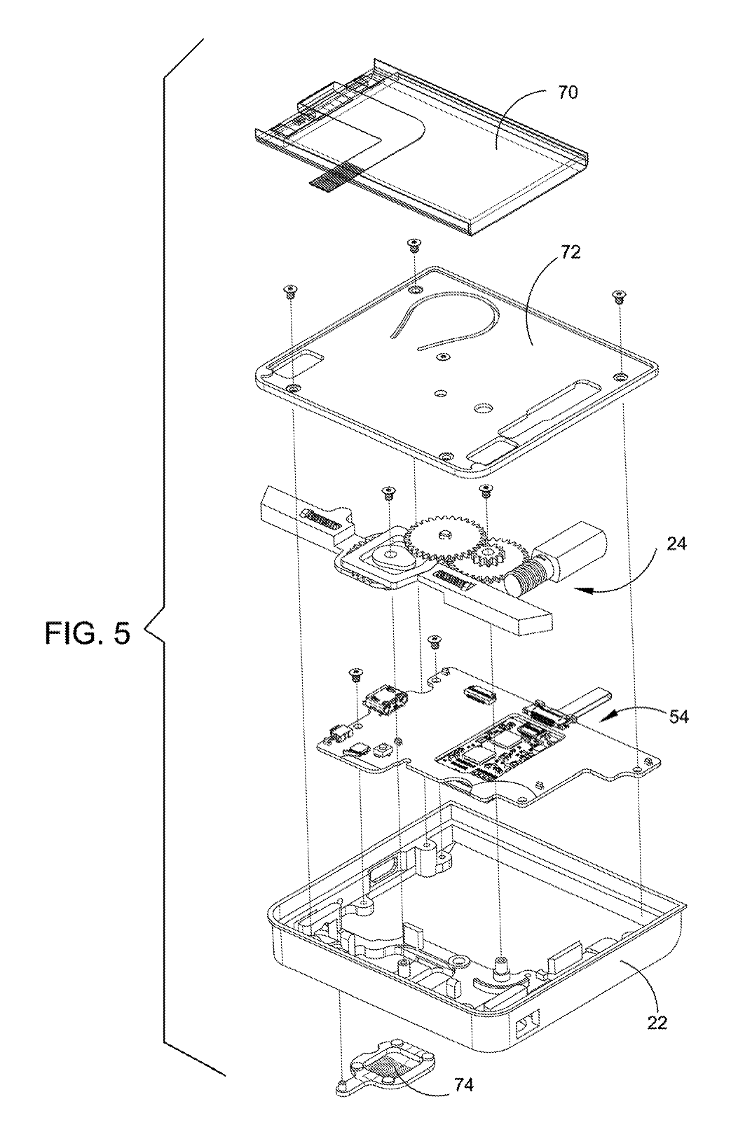

FIG. 5 depicts an exploded view of the Biometric and Bluetooth Enabled Case Lock 10 assembly illustrating the battery 70, the cover plate 72, latch link assembly 24 and the PC board assembly 54 and the Biometric and Bluetooth Enabled Case Lock frame 22. Below the Biometric and Bluetooth Enabled Case Lock frame 22 is the home button 74 that wakes up the finger print sensor.

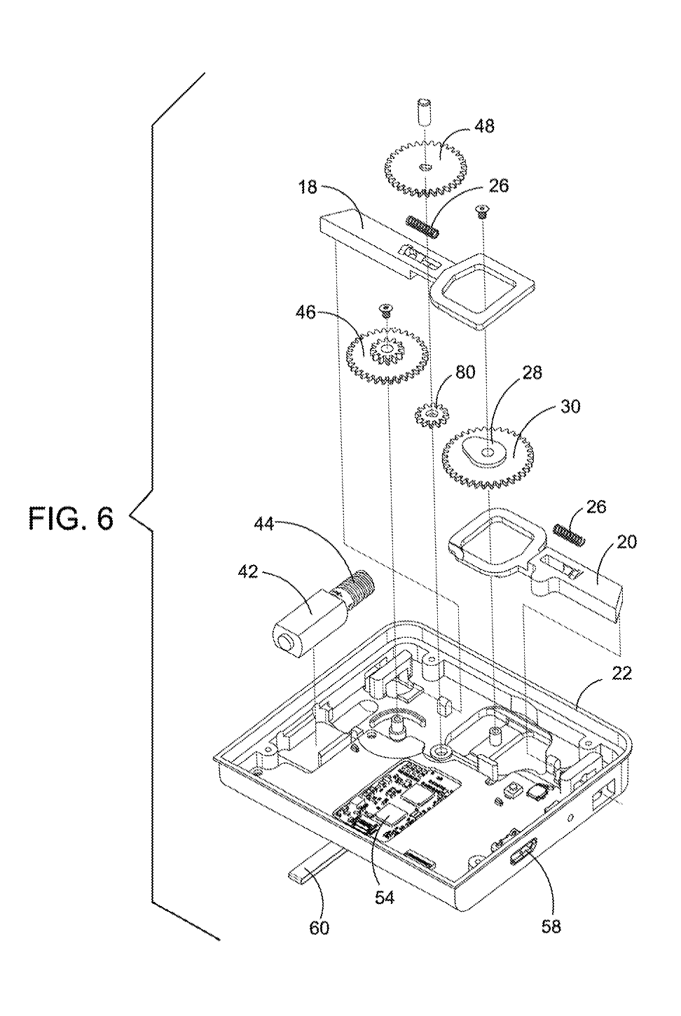

FIG. 6 depicts an exploded view of the Biometric and Bluetooth Enabled Case Lock 10 mechanical components illustrating the thirty-two tooth gear 48 incorporating a twelve tooth gear 80, the bottom latch link 18 with the latch return spring 26, thirty-two tooth gear incorporating a twelve tooth gear 46 and the thirty-six tooth gear assembly 30 with the top and bottom cams 28. The top latch link 20 and latch return spring 26 and the drive motor 42 with the worm gear 44 are raised above the Biometric and Bluetooth Enabled Case Lock frame 22. The PCB 54, USB charging port and the antenna 60 are incorporated within the Biometric and Bluetooth Enabled Case Lock frame.

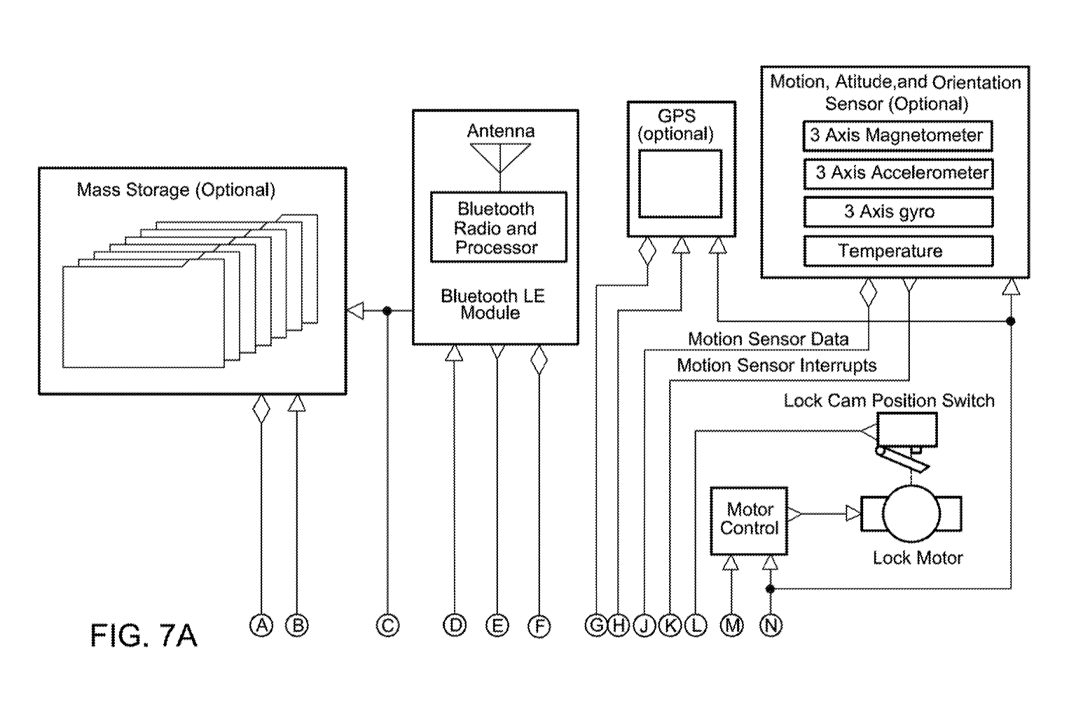

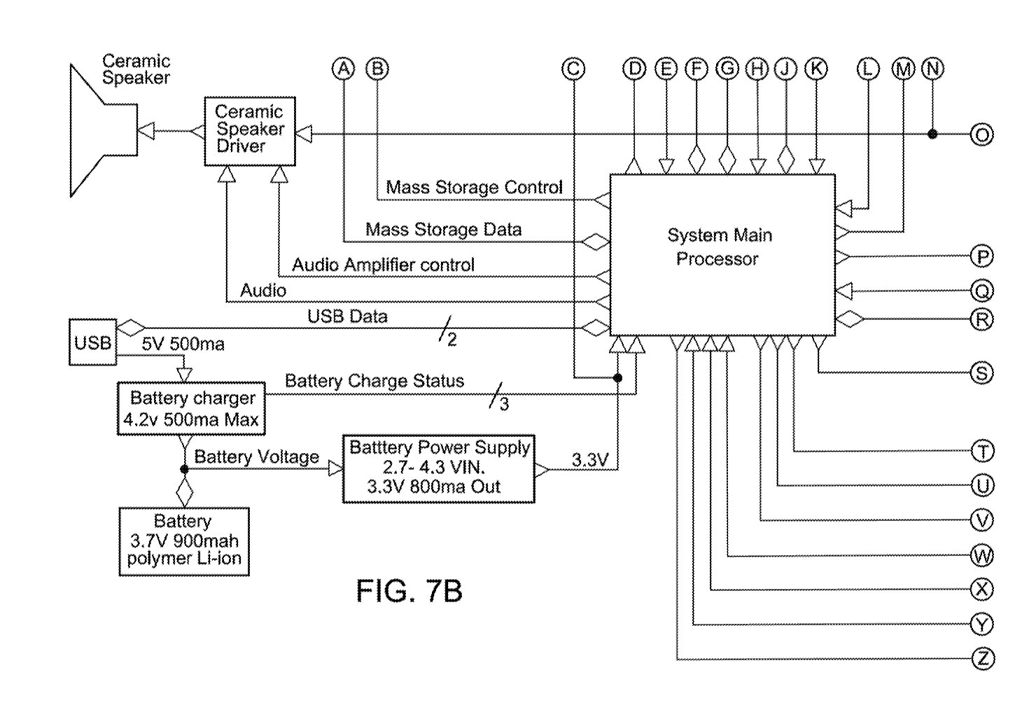

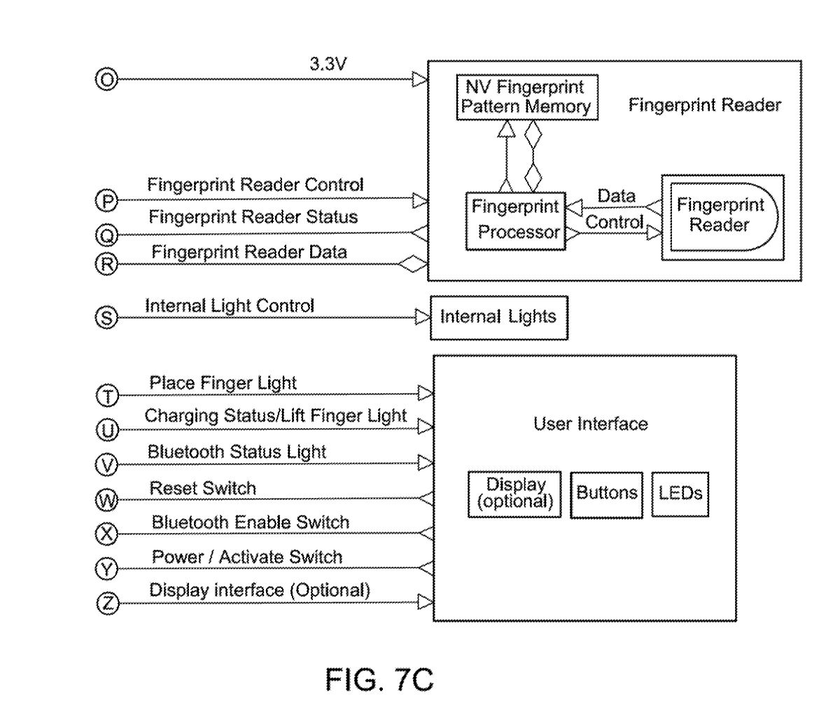

FIG. 7A depicts a block diagram illustration of the system components for the Biometric and Bluetooth Enabled Case Lock assembly including the motor control, lock, Bluetooth antenna and Bluetooth module as well as optional mass storage, GPS and motion sensor.

FIG. 7B depicts a block diagram illustration of the hardware components for the Biometric and Bluetooth Enabled Case Lock assembly, including the main processor, speaker driver and speaker, as well as the USB port and battery power supply configurations.

FIG. 7C depicts a block diagram illustration hardware and software components for the Biometric and Bluetooth Enabled Case Lock assembly, including the fingerprint reader, internal lights and user interface.

In this regard, referring now to FIGS. 7A, 7B and 7C, the outline provides a hardware design for a Biometric and Bluetooth Enabled Case Lock with all optional equipment included. Items listed as ‘standard equipment’ will be included on all Biometric and Bluetooth Enabled Case Lock product designs. Items listed as ‘optional equipment’ may be included or omitted in any combination in a specific design as may be required by a final product definition.

System Processor (standard equipment) Controls the overall operation of the unit.
a. Interprets the user's inputs and converts them into commands which control the fingerprint enrollment and identification process.
b. Controls a solenoid/lock motor and monitors the solenoid/lock motor position feedback operation.
c. Controls and interprets commands passed from the user's external Bluetooth device.
d. Manages system power usage.
e. Controls the operation of all LED's (Status LEDs and Hood Light).
f. Monitors and records motion sensor data.
g. Monitors and records temperature sensor readings.
h. Manages the Real Time Clock for time-lock and alarm operation.
i. Supports USB communication for direct connect setup and firmware updating.
j. Monitors the battery voltage and reports battery status via status LEDs and Bluetooth.
k. Optionally monitors and records GPS Data.

Blue Tooth LE Module (Standard Equipment)

Control the Bluetooth radio link to the users' smart phone or other compatible intelligent device. Receives commands and alerts from the external device and passes them to the System Processor for action. Also receives command and control data from the System Processor and passes that data to the external device via the Bluetooth link.

Fingerprint Sensor (Standard Equipment)

The device on which the users places their finger to enroll a finger or to unlock the device.

Fingerprint Coprocessor (Standard Equipment)

Receives commands from the System Processor and then controls the operation of the fingerprint sensor.

USB Interface (Standard Equipment)

The USB interface is used both to provide charging power for the battery and to control and setup the device with the individual user preferences and also allows reading the mass storage memory if equipped.

Battery (Standard Equipment)

The battery provides all power to the system during normal operation

Power Supply (Standard Equipment)

Provide the system with the regulated voltages that are required for the system to operate.

Battery Charger (Standard Equipment)

Provides controls and monitors the battery charge cycle when the unit is plugged into a USB port or USB wall charger.

Status LEDs (Standard Equipment)

The Status LEDs are used to convey unit status and also to prompt the user to perform some action like placing a finger on or lifting a finger from the fingerprint touch sensor.
a. Green LED blinks slowly when battery is charging and is on solid when the battery if fully charged. One long blink indicates user should place their finger on the fingerprint sensor. Green LED is off when in standby mode.
b. Red LED flickers at a slow rate to indicate the battery is in need of charging. One long blink indicates the user should lift their finger from the fingerprint sensor. Red LED is off when in standby mode.
c. Blue LED conveys the current state of the Bluetooth link.

Internal Lighting (Standard Equipment)

These lights illuminate the contents of the case momentarily when opened in low light conditions.

Lock Status Switch (Standard Equipment)

Signals the main processor when the Solenoid/lock motor has completed the full Unlock/Relock cycle.

Activate/Power Button (Standard Equipment)

Powers the unit on if it is off and requests the user to input a fingerprint to unlock the unit. If the unit is already on or in standby mode, the unit will just request that the user inputs a fingerprint to unlock the unit.

Bluetooth Enable Button (Standard Equipment)

Used to enable and disable the Bluetooth link to the user's external device.

Reset Button (Standard Equipment)

The reset button is accessed via a small diameter hole somewhere on the device. The button is activated by inserting the tip of a paperclip straight into the hole until clicks. This is used to restart the main processor in the event of trouble. The unit will restart with all previous settings intact. An alarm will sound for a few seconds and the user will be prompted to place their finger on the fingerprint reader.

Solenoid/Lock Motor Control (Standard Equipment)

Provides power to the Solenoid/lock motor when requested by the System Processor

Solenoid/Lock Motor (Standard Equipment)

Electromechanical device which unlocks and relocks the unit.

Alarm Amplifier (Standard Equipment)

Amplifies the low power audio signals from main processor to the high power signal required by the alarm speaker.

Alarm Speaker (Standard Equipment)

Provides the sounds which alert the user about a status change of the device which requires their attention.

GPS Sensor (Standard Equipment)

Allows global position information to be tracked, monitored and recorded

Wi-Fi Connectivity (Optional Equipment)

Allows long distance control, access and monitoring of the unit.

Temperature Sensor (Optional Equipment)

Allows the monitoring of environmental conditions in the device which may be detrimental to the contents. An alarm may be triggered or the temperature profile may be recorded over time for later analysis.

Axis Accelerometer (Optional Equipment)

Can be used to prevent the device from being opened while not being held at a specific angle. Can also be used to detect or record rough handling of the device. May also trigger an alarm if not handled as instructed.

Axis Magnetometer (Optional Equipment)

Can be programmed to trigger an alarm if the device is physically moved. Provides a virtual lock in place function.

Axis Gyroscope (Optional Equipment)

May be programmed to trigger an alarm when the device is rotated in any axis at a rate greater than a fixed value.

Display (Optional Equipment)

A custom display may be added for applications that require more complex user interaction.

Mass Storage Device (Option Equipment)

Allows storage and recall of sensor history data such as temperature, motion and when and where the device was opened.

The Biometric and Bluetooth Enabled Case Lock 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Case Lock 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A biometric and Bluetooth enabled case lock system comprising:
a frame, incorporating a locking latch and lock solenoid/motor;
a biometric access module;
a Bluetooth communications access module;
wherein access to the locking latch for locking and unlocking the case lock is controlled by said biometric access module and said Bluetooth communications access module; and
whereby said case lock system is controllable via an application on a smartphone, tablet or a computer.

2. The biometric and Bluetooth enabled case lock system according to claim 1, wherein said frame, incorporating a locking latch includes an attaché case, luggage, briefcases, lockers, lock boxes and cabinets.

3. The biometric and Bluetooth enabled case lock system according to claim 1, wherein said biometric access module and said Bluetooth communications access module include indirect operational control of said locking latch by an on-board system processor in communication with an application on a smart phone, tablet or a computer.

4. The biometric and Bluetooth enabled case lock system according to claim 1, wherein said on-board system processor includes a system processor to control the overall operation of the unit.

5. The biometric and Bluetooth enabled case lock system according to claim 1, wherein said system processor interprets the user's inputs and converts them into commands which control the fingerprint enrollment and identification process.

6. The biometric and Bluetooth enabled case lock system according to claim 1, wherein said system processor controls said solenoid/lock motor and monitors the solenoid/lock motor position feedback operations.

7. The biometric and Bluetooth enabled case lock system according to claim 1, wherein said Bluetooth communications access module includes a system processor which controls and interprets commands passed from the user's external Bluetooth device.

8. The biometric and Bluetooth enabled case lock system according to claim 1, wherein said case lock system includes a system processor, a GPS sensor, one or more LED's including status LED's and a hood light, a motion sensor, a temperature sensor, and a real time clock.

9. The biometric and Bluetooth enabled case lock system according to claim 1, wherein said system processor manages system power usage, controls the operation of all LED's including status LED's and a hood light, monitors and records GPS position data, motion sensor data, monitors and records temperature sensor readings, and manages the real time clock for time-lock and alarm operations.

10. The biometric and Bluetooth enabled case lock system according to claim 1, wherein said system processor facilitates access to the locking latch for locking and unlocking the case lock and controls said biometric access module and said Bluetooth communications access module.

11. A method for making a biometric and Bluetooth enabled case lock system, comprising the steps of:
providing a frame, incorporating a locking latch and solenoid/lock motor;
connecting a biometric access module to said frame; and
connecting a Bluetooth communications access module to said frame;
wherein access to the locking latch for locking and unlocking the case lock is controlled by said biometric access module and said Bluetooth communications access module; and
whereby said case lock system is controllable via an application on a smartphone, tablet or a computer.

12. The method for making a biometric and Bluetooth enabled case lock system according to claim 11, wherein said frame, incorporating a locking latch includes an attaché case, luggage, briefcases, lockers, lock boxes and cabinets.

13. The method for making a biometric and Bluetooth enabled case lock system according to claim 11, wherein said biometric access module and said Bluetooth communications access module include indirect operational control of said locking latch by an on-board system processor in communication with an application on a smart phone, tablet or a computer.

14. The method for making a biometric and Bluetooth enabled case lock system according to claim 11, wherein said on-board system processor includes a system processor to control the overall operation of the unit.

15. The method for making a biometric and Bluetooth enabled case lock system according to claim 11, wherein said system processor interprets the user's inputs and converts them into commands which control the fingerprint enrollment and identification process.

16. The method for making a biometric and Bluetooth enabled case lock system according to claim 11, wherein said system processor controls said solenoid/lock motor and monitors the solenoid/lock motor position feedback operations.

17. The method for making a biometric and Bluetooth enabled case lock system according to claim 1 wherein said Bluetooth communications access module includes a system processor which controls and interprets commands passed from the user's external Bluetooth device, whereby said case lock system is controllable via an application on a smartphone, tablet or a computer.

18. The method for making a biometric and Bluetooth enabled case lock system according to claim 11, wherein said case lock system includes a system processor, one or more LED's including status LED's and a hood light, a GPS sensor, a motion sensor, a temperature sensor, and a real time clock.

19. The method for making a biometric and Bluetooth enabled case lock system according to claim 11, wherein said system processor manages system power usage, controls the operation of all LED's including status LED's and a hood light, monitors and records GPS position data, motion sensor data, monitors and records temperature sensor readings, and manages the real time clock for time-lock and alarm operations.

20. The method for making a biometric and Bluetooth enabled case lock system according to claim 11, wherein said system processor facilitates access to the locking latch for locking and unlocking the case lock and controls said biometric access module and said Bluetooth communications access module.
